(19) United States
(12) Patent Application Publication
(10) Pub. No.: US 2004/0123070 A1
(43) Pub. Date: Jun. 24, 2004

(54) Automatic detection of different microprocessor architectures

(76) Inventors: Dale J. Shidla, Roseville, CA (US); Andrew H. Barr, Roseville, CA (US); Jacky Tsun-Yao Chang, Rocklin, CA (US)

Correspondence Address: HEWLETT-PACKARD COMPANY, Intellectual Property Administration, P.O. Box 272400, Fort Collins, CO, 80527-2400, US

(21) Appl. No.: 10/328,906

(22) Filed: Dec. 23, 2002

(51) Int. Cl. G06F 15/00

(52) U.S. Cl. 712/1

(57) ABSTRACT

A method for providing automatic detection of different microprocessor architectures within a system. The method may include determining whether a first microprocessor architecture or a second microprocessor architecture is resident to the system. Provided the first microprocessor architecture is resident to the system, the method may include providing first data to activate first architecture support of the system associated with the first microprocessor architecture. Provided the second microprocessor architecture is resident to the system, the method may include providing second data to activate second architecture support of the system associated with the second microprocessor architecture.

### BACKGROUND ART

Computers have become integral tools used in a wide variety of different applications, such as in finance and commercial transactions, computer-aided design and manufacturing, health care, telecommunication, education, etc. Computers are finding new applications as a result of advances in hardware technology and rapid development in software technology. Furthermore, the functionality of a computer system is dramatically enhanced by coupling these types of stand-alone devices together in order to form a networking environment. Within a networking environment, users may readily exchange files, share information stored on a common database, pool resources, and communicate via electronic mail (e-mail) and video teleconferencing. Furthermore, computers which are coupled to a networking environment like the Internet provide their users access to data and information from all over the world.

It is understood that one of the many components that enables networking environments and the sharing of data and information between computer systems is server computers. However, with the continuing advances of hardware technology and software technology, it sometimes becomes desirable for server owners, such as companies or corporations, to transition from their current server platform involving a particular microprocessor architecture to another server platform of a different microprocessor architecture. In order to do this, server owners typically discard their current server platform and purchase the new more desirable server platform. However, there are disadvantages associated with transitioning from one server microprocessor architecture to another server microprocessor architecture.

For example, one of the disadvantages is that it is typically expensive for server owners to transition from one server microprocessor architecture to a different server microprocessor architecture. And it is appreciated that as the number of servers to replace increases, the overall replacement cost usually becomes more and more expensive.

Accordingly, a need exists for a way to transition from one server microprocessor architecture to a different server microprocessor architecture without it being overly expensive.

### DISCLOSURE OF THE INVENTION

A method for providing automatic detection of different microprocessor architectures within a system. The method may include determining whether a first microprocessor architecture or a second microprocessor architecture is resident to the system. Provided the first microprocessor architecture is resident to the system, the method may include providing first data to activate first architecture support of the system associated with the first microprocessor architecture. Provided the second microprocessor architecture is resident to the system, the method may include providing second data to activate second architecture support of the system associated with the second microprocessor architecture.

### BRIEF DESCRIPTION OF THE DRAWINGS

FIG. 1 is a flowchart of steps performed in accordance with an embodiment of the present invention for providing automatic detection of different microprocessor architectures within a computer system.

FIG. 2 is a flowchart of steps performed in accordance with an embodiment of the present invention for automatically detecting different microprocessor architectures within a computer system.

FIG. 3 is a block diagram of exemplary hardware that may be utilized to automatically detect different microprocessor architectures within a computer system in accordance with an embodiment of the present invention.

FIG. 4 is a block diagram of an embodiment of an exemplary computer system that may be used in accordance with the present invention.

### MODE(S) FOR CARRYING OUT THE INVENTION

Reference will now be made in detail to embodiments of the invention, examples of which are illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the present invention.

### Notation and Nomenclature

Some portions of the detailed descriptions which follow are presented in terms of procedures, logic blocks, processing, and other symbolic representations of operations on data bits within a computing system or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps may involve physical manipulations of physical quantities. Usually, though not necessarily, these physical manipulations take the form of electrical or magnetic signals capable of being stored, transferred, combined, compared, and otherwise manipulated in a computing system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “determining”, “processing”, “performing”, “deciding”, “ascertaining”, “transmitting”, “receiving”, “retrieving”, “providing”, “presenting”, “furnishing”, “activating”, “enabling”, “recognizing”, “generating”, “utilizing”, “implementing”, “employing”, “storing” or the like, refer to the action and processes of a computing system, or similar electronic computing device, that manipulates and transforms data. The data is represented as physical (electronic) quantities within the computing system's registers and memories and is transformed into other data similarly represented as physical quantities within the computing system's memories or registers or other such information storage, transmission, or display devices.

### Exemplary Operations in Accordance with the Present Invention

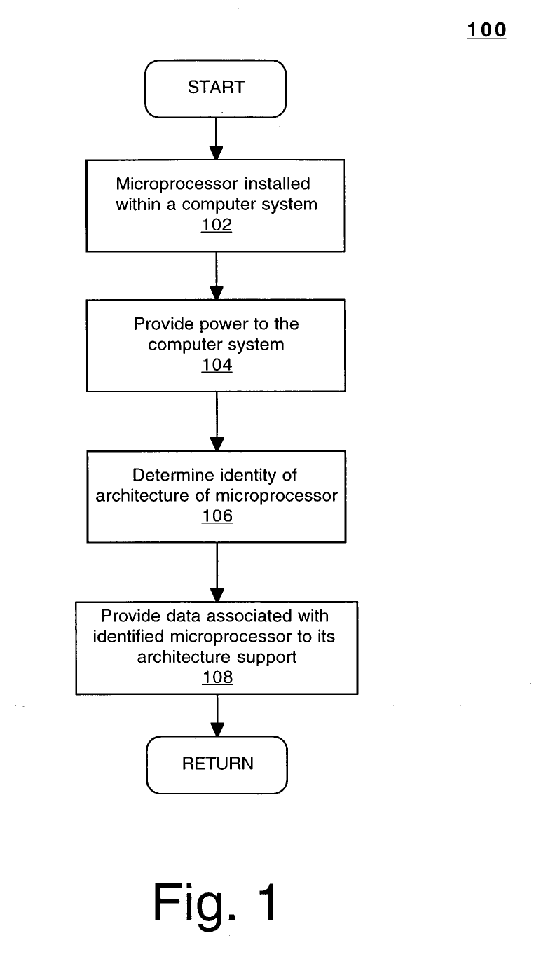

FIG. 1 is a flowchart 100 of steps performed in accordance with an embodiment of the present invention for providing automatic detection of different microprocessor architectures within a computer system. Flowchart 100 includes processes of the present invention which, in one embodiment, are carried out by a processor(s) and electrical components under the control of computer readable and computer executable instructions. The computer readable and computer executable instructions may reside, for example, in data storage features such as computer usable volatile memory, computer usable non-volatile memory and/or computer usable mass data storage. However, the computer readable and computer executable instructions may reside in any type of computer readable medium. Although specific steps are disclosed in flowchart 100, such steps are exemplary. That is, the present embodiment is well suited to performing various other steps or variations of the steps recited in FIG. 1. Within the present embodiment, it should be appreciated that the steps of flowchart 100 may be performed by hardware, by software or by any combination of software and hardware.

The present embodiment provides a method for providing automatic detection of different microprocessor architectures within a computer system. For example, when a microprocessor of a given architecture is installed within the computer system and power is provided to the system, a determination is made as to the architectural identity of the microprocessor installed within the computer system. That is, an identifier associated with the installed microprocessor's architecture is detected in order to determine its identity. Once the microprocessor has been identified, data corresponding to the identified microprocessor is provided to its architecture support that is resident to the computer system. In this manner, a microprocessor of a given architecture installed on the computer system is automatically detected and functionally accommodated. As such, the computer system may utilize different microprocessors having different architectures. Therefore, a microprocessor having a different architecture may be installed within the computer system. In this manner, an entirely new computer system does not need to be purchased thereby reducing the expense of transitioning from one microprocessor architecture to another microprocessor architecture. Additionally, familiar software applications may still be able to be utilized by users of the changed computer system.

At step 102 of FIG. 1, a microprocessor of a given architecture is installed within a computer system. It is noted that the computer system may include, but is not limited to, a server, a desktop computer, a laptop computer or a portable computing device. Furthermore, within one embodiment, when the microprocessor is installed within the computer system it is electrically coupled to the computer system. For example, the microprocessor may be installed into a socket capable of electrically coupling the computer system to pins of the microprocessor. Furthermore, multiple microprocessors of differing architectures may be implemented so that they may be installed into a common microprocessor socket.

In step 104, power is provided to the computer system. For example, the power supply of the computer system may be switched on in order to activate the computer system.

At step 106, a determination is made as to the architectural identity of the microprocessor resident to the computer system. It is noted that the architectural identifier of the microprocessor may be a wide variety of things in accordance with the present embodiment. For example, the identifier of the microprocessor may be stored within memory resident to the microprocessor that may be read by the present embodiment. Alternatively, the identifier of the microprocessor may be a particular voltage level or electrical difference at one or more of the microprocessor's pins that may be detected by a sensor, such as, a voltage sensor.

At step 108 of FIG. 1, data corresponding to the identified microprocessor's architecture is provided to its architecture support of the computer system. It is understood that the architecture support of the identified microprocessor may be implemented in diverse ways in accordance with the present embodiment. For example, the architecture support may include, but is not limited to, system level firmware, hardware and/or software for supporting the operation of the identified microprocessor. In this manner, the present embodiment is able to automatically provide the appropriate architectural mode for the identified architectural of the microprocessor. It is appreciated that the provided data may include, but is not limited to, an electronic signal, a bit, a byte or bytes presented to the architecture support associated with the identified microprocessor of the computer system. Once step 108 is completed, the present embodiment exits flowchart 100.

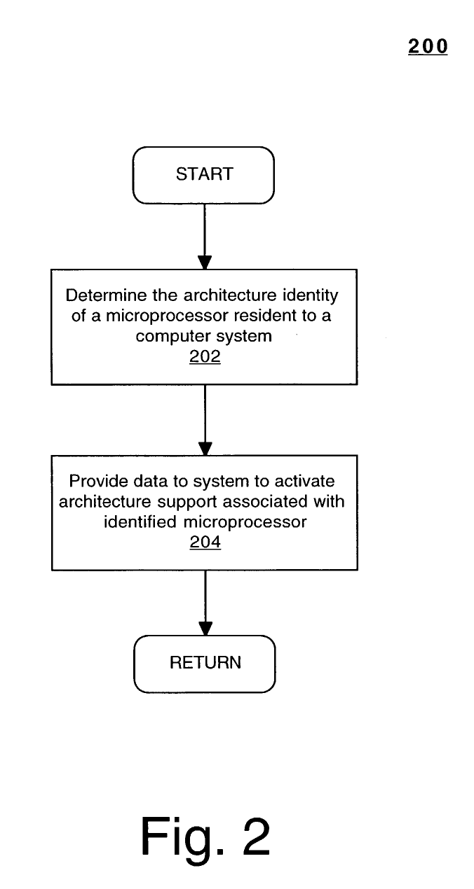

FIG. 2 is a flowchart 200 of steps performed in accordance with an embodiment of the present invention for automatically detecting different microprocessor architectures within a computer system. Flowchart 200 includes processes of the present invention which, in one embodiment, are carried out by a processor(s) and electrical components under the control of computer readable and computer executable instructions. The computer readable and computer executable instructions may reside, for example, in data storage features such as computer usable volatile memory, computer usable non-volatile memory and/or computer usable mass data storage. However, the computer readable and computer executable instructions may reside in any type of computer readable medium. Although specific steps are disclosed in flowchart 200, such steps are exemplary. That is, the present embodiment is well suited to performing various other steps or variations of the steps recited in FIG. 2. Within the present embodiment, it should be appreciated that the steps of flowchart 200 may be performed by hardware, by software or by any combination of software and hardware.

The present embodiment provides a method for automatically detecting different microprocessor architectures within a computer system. For example, a determination is made as to the identity of a microprocessor's architecture resident to the computer system. That is, an architectural identifier associated with the microprocessor may be detected in order to determine its identity. Once the microprocessor's architecture is identified, data is furnished to the computer system in order to activate architecture support associated with the identified microprocessor. In this manner, the microprocessor's architecture resident to the computer system is automatically detected and functionally accommodated. Therefore, the computer system is capable of utilizing processors of differing architectures at different times.

At step 202 of FIG. 2, a determination is made as to the identity of a microprocessor of a given architecture resident to a computer system. It is understood that the microprocessor may be resident to the computer system in a wide variety of ways. For example, the microprocessor may be resident to the computer system when it is installed within the computer system. Alternatively, the microprocessor may be resident to the computer system when it is electrically coupled to the computer system. For instance, the microprocessor may be electrically coupled to the computer system via a microprocessor socket. However, the present embodiment is not strictly limited to such implementations. Additionally, it is noted that the computer system of the present embodiment may be implemented in diverse ways. For example, the computer system may include, but is not limited to, a server, a desktop computer, a laptop computer or a portable computing device.

It is noted that the architectural identity of the microprocessor may be determined at step 202 in a wide variety of ways in accordance with the present embodiment. For example, the architectural identity of the microprocessor may be determined by reading a predefined or known identifier stored by memory resident to the microprocessor. Alternatively, the architectural identity of the microprocessor may be determined by detecting a particular voltage level or electrical difference at one or more interface pins of the microprocessor.

At step 204 of FIG. 2, data is provided (or furnished) to the computer system in order to activate architecture support associated with the identified architecture of the microprocessor. In this manner, the computer system is able to automatically provide the appropriate architectural mode for the identified microprocessor architecture. It is appreciated that the architecture support associated with the identified microprocessor may be implemented in diverse ways in accordance with the present embodiment.

For example, the architecture support may include firmware for supporting the operation of the identified microprocessor. Additionally, the architecture support may include hardware that supports operations of the identified microprocessor architecture. Moreover, the architecture support may include software that supports the operation of the identified microprocessor. It is understood that the architecture support may include any of those embodiments recited herein. However, the architecture support of the present embodiment is not limited to any of these recited implementations. It is appreciated that the data provided may include, but is not limited to, a signal, a bit, a byte, bytes or the like presented to the architecture support of the identified microprocessor associated with the computer system. Once step 204 is completed, the present embodiment exits flowchart 200.

### Exemplary Hardware in Accordance with the Present Invention

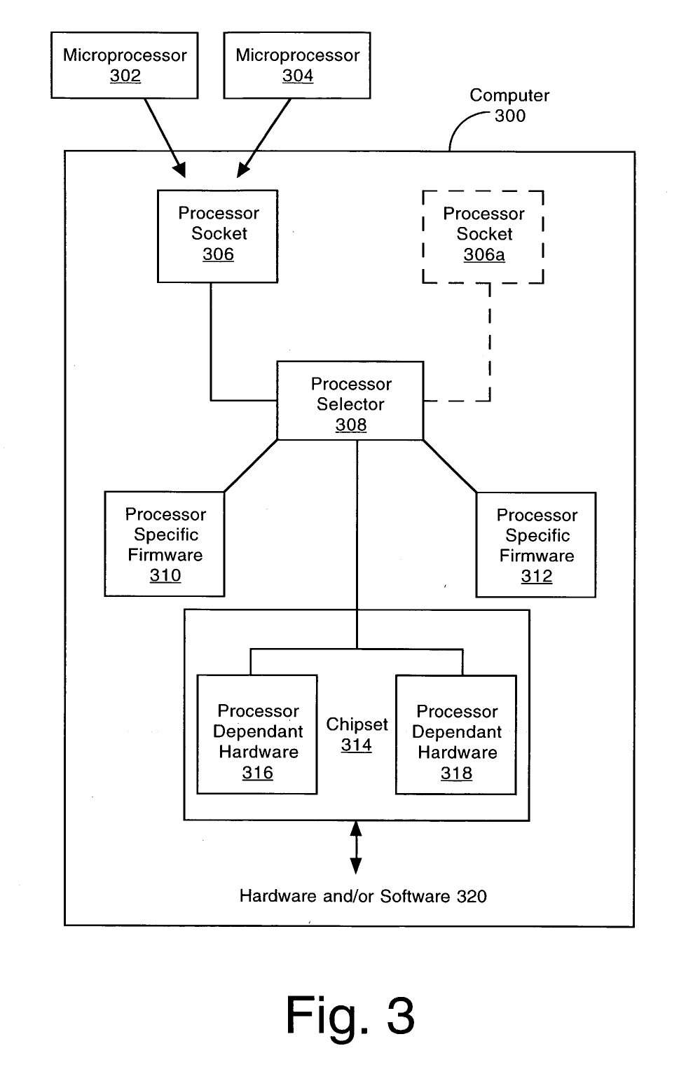

FIG. 3 is a block diagram of exemplary hardware that may be utilized to automatically detect different microprocessor architectures within a computer system 300 in accordance with an embodiment of the present invention. It is understood that the implementation of an instruction set architecture (ISA) in a microprocessor design typically yields a set of features specific to that particular architecture. In microprocessor designs, this uniqueness usually manifests itself in the form of signals that perform functionality and/or have electrical qualities at the processor/system interface that are architecture-specific. The present embodiment may exploit these differences, whatever they may be, and use them to provide information to portions of system 300. Keying off of these types of differences provides a detection system with information to determine the architecture of the microprocessor(s) used, allowing system-level hardware, firmware and/or software to take the appropriate actions to turn system 300 on in the appropriate architectural mode. Therefore, the present embodiment facilitates a single system that supports microprocessors from multiple instruction set architectures on a common hardware platform.

It is noted that the architecture of microprocessor 302 is different than the architecture of microprocessor 304. As such, when a microprocessor (e.g., 302 or 304) of a given architecture is installed within a microprocessor socket 306 of a computer system 300 and power is provided to system 300, a processor selector module 308 determines the identity of the architecture of the microprocessor (e.g., 302). Specifically, an identifier associated with the installed microprocessor 302 is detected by the processor selector module 308 in order to determine its architecture identity.

Once the architecture of microprocessor 302 has been identified, data associated with microprocessor 302 is provided by the processor selector 308 to architecture support resident to the computer system 300. It is noted that the architecture support may include, but is not limited to, system level firmware, hardware and/or software that supports the operation of the identified architecture of microprocessor 302. In this manner, the computer system 300 automatically provides the appropriate architectural mode for the identified architecture of microprocessor 302. Therefore, when a microprocessor (e.g., 302 or 304) is installed on the computer system 300, its architecture is automatically detected and functionally accommodated.

It is noted that the processor selector 308 is capable of detecting a known or predefined architecture identifier of a microprocessor (e.g., 302 or 304) coupled to socket 306. The architecture identifier may be implemented in a wide variety of ways in accordance with the present embodiment. For example, a sensor (not shown) may be implemented as part of processor selector module 308 and coupled to monitor electrical qualities of one or more interface pins of a microprocessor (e.g., 302 or 304) when coupled to socket 306. As such, the processor selector 308 is able to identify the architecture of the microprocessor (e.g., 302 or 304) coupled to socket 306. Alternatively, the architecture identity of the installed microprocessor (e.g., 302 or 304) may be determined by processor selector module 308 reading a predefined or known identifier stored by memory resident to the installed microprocessor. Therefore, the processor selector 308 is able to identify the architecture of a microprocessor (e.g., 302 or 304) coupled to socket 306.

Within FIG. 3, upon determining the architectural identity of microprocessor 302 coupled to socket 306, the processor selector module 308 outputs a signal or data in order to activate the appropriate firmware (e.g., 310 or 312) that provides architectural support to the identified microprocessor 302. It is appreciated that firmware 310 and 312 may each provide architectural support to a different microprocessor architecture. For example, firmware 310 may provide architectural support to the architecture of microprocessor 302 while firmware 312 may provide architectural support to the different architecture of microprocessor 304. Additionally, firmware 310 and 312 may each provide architectural support to multiple microprocessors having similar architecture. It is noted that the firmware usually is the lowest level instruction set for a microprocessor which may include, but is not limited to, boot-up code, self test functionality, memory test functionality, error handling, and an interface between an operating system (OS) and applications and hardware of system 300. Furthermore, the firmware (e.g., 310 or 312) may be stored by memory (not shown) communicatively coupled to system 300.

Additionally, upon determining the architecture identity of microprocessor 302 coupled to socket 306, the processor selector module 308 outputs a signal or data in order to activate microprocessor dependant hardware (e.g., 316 or 318) that may be resident on a chipset 314. The activated microprocessor dependant hardware (e.g., 316 or 318) supports the operation of the identified architecture of microprocessor 302. It is understood that hardware 316 and 318 may each provide architectural support to a different microprocessor architecture. For example, hardware 316 may provide architectural support to the architecture of microprocessor 302 while hardware 318 may provide architectural support to the different architecture of microprocessor 304. However, in one embodiment a processor dependant hardware (e.g., 316) may be implemented to provide architectural support to the differing architectures of microprocessors 302 and 304. In such an embodiment, it is noted that the other processor dependant hardware (e.g., 318) may not need to be implemented as part of system 300. Additionally, hardware 316 and 318 may each provide architectural support to multiple microprocessors having similar architecture. It is noted that the chipset 314 is coupled to interact with hardware and/or software 320 of system 300.

In one embodiment, computer system 300 of FIG. 3 may be specifically implemented to accommodate the Intel Itanium 2 processor and the HP PA-8800 processor. The first processor implements the Intel Itanium Processor Family architecture while the second processor implements the HP PA-RISC architecture. It is noted that the HP PA-8800 processor is designed to utilize the same front-side bus interface (not shown) that the Intel Itanium 2 processor uses to interface with the rest of the system 300. Within the Itanium 2 processor's pin array, certain pins are defined as “depopulated” or “no-connects” and thus have no functionality and are electrically static. It is noted that the PA-8800 processor utilizes the core set of signals on the front-side bus in a manner consistent with the Itanium 2 processor. Furthermore, the PA-8800 processor also uses the signals designated by the Itanium 2 processor as no-connects or depopulated to implement PA-8800 processor specific functionality. This allows the PA-8800 processor to maintain compatibility with the Itanium 2 processor bus interface while enabling features specific to itself. The PA-8800 processor's orthogonal utilization of these pins provide electrical differences that the processor selector module 308 can key off of. In turn, this information can be used to generate logic that selects the correct architecture specific firmware (e.g., 310 or 312) to boot system 300, activate any circuitry (e.g., 316 or 318) specific to a given architecture, allow system chipset 314 to appropriately transaction to and from the microprocessors, etc.

For example, pin B01 in the Itanium 2 processor pin array is a depopulated pin. The same B01 pin in the PA-8800 processor delivers 2.5 V to the microprocessor to enable functionality specific to the PA-8800 processor. As such, a voltage sense placed on this pin can then be used to distinguish between when an Itanium 2 processor is coupled to socket 306 versus when a PA-8800 processor is coupled to socket 306.

Within FIG. 3, computer system 300 includes processor socket 306 which is coupled to the processor selector module 308. It is noted that system 300 may be implemented with additional microprocessor sockets (e.g., 306a) for receiving one or more microprocessors (e.g., 302 and 304). In such an embodiment, the additional microprocessor sockets (e.g., 306a) are coupled to the processor selector module 308. Additionally, the processor selector 308 is communicatively coupled to processor specific firmware 310 and 312. It is understood that computer system 300 may include any number of processor specific firmware that may be requisite to support the microprocessors that may be accepted and utilized by system 300. The processor selector 308 is also communicatively coupled to chipset 314 and processor dependant hardware 316 and 318. It is appreciated that computer system 300 may include any number of processor dependant hardware requisite to support the microprocessors that may be accepted and utilized by system 300. The chipset 314 is coupled to the hardware and/or software 320 of computer system 300.

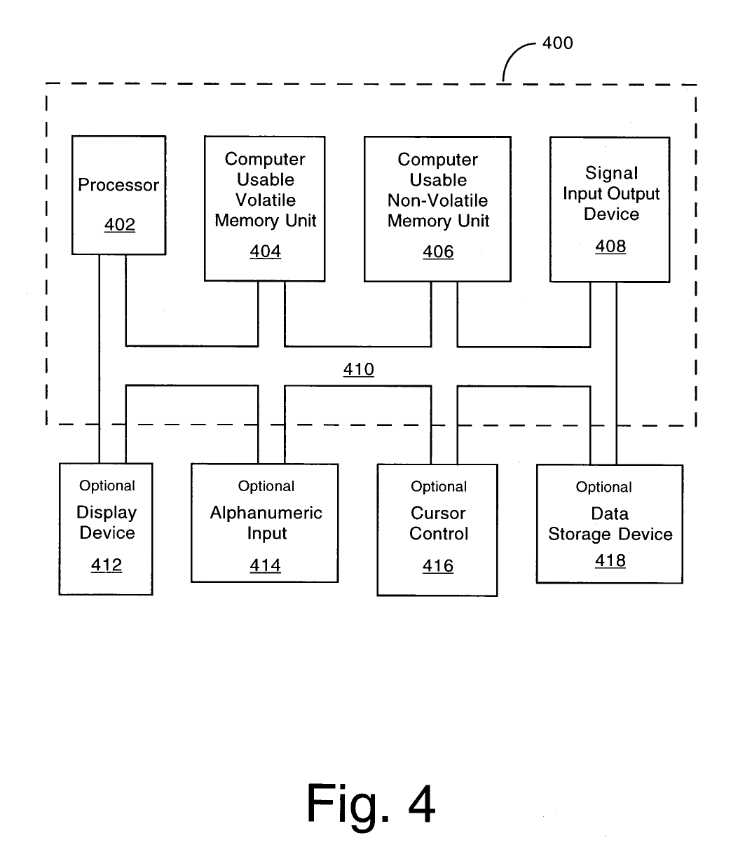

FIG. 4 is a block diagram of an embodiment of an exemplary computer system 400 that may be used in accordance with the present invention. It is understood that system 400 is not strictly limited to be a computer system. As such, system 400 of the present embodiment is well suited to be any type of computing device (e.g., server computer, desktop computer, laptop computer, portable computing device, etc.). It is noted that computer system 300 may be implemented to include some or all of the components of computer system 400.

Computer system 400 of FIG. 4 comprises an address/data bus 410 for communicating information, one or more central processors 402 coupled with bus 410 for processing information and instructions. Central processor unit(s) 402 may be a microprocessor or any other type of processor. The computer 400 also includes data storage features such as a computer usable volatile memory unit 404, e.g., random access memory (RAM), static RAM, dynamic RAM, etc., coupled with bus 410 for storing information and instructions for central processor(s) 402, a computer usable non-volatile memory unit 406, e.g., read only memory (ROM), programmable ROM, flash memory, erasable programmable read only memory (EPROM), electrically erasable programmable read only memory (EEPROM), etc., coupled with bus 410 for storing static information and instructions for processor(s) 402.

System 400 also includes one or more signal generating and receiving devices 408 coupled with bus 410 for enabling system 400 to interface with other electronic devices. The communication interface(s) 408 of the present embodiment may include wired and/or wireless communication technology. For example, in one embodiment of the present invention, the communication interface 408 is a serial communication port, but could also alternatively be any of a number of well known communication standards and protocols, e.g., a Universal Serial Bus (USB), an Ethernet adapter, a FireWire (IEEE 1394) interface, a parallel port, a small computer system interface (SCSI) bus interface, an infrared (IR) communication port, a Bluetooth wireless communication adapter, a broadband connection, and the like. In another embodiment, a digital subscriber line (DSL) connection may be employed. In such a case the communication interface(s) 408 may include a DSL modem. Additionally, the communication interface(s) 408 may provide a communication interface to the Internet.

Optionally, computer system 400 can include an alphanumeric input device 414 including alphanumeric and function keys coupled to the bus 410 for communicating information and command selections to the central processor(s) 402. The computer 400 can also include an optional cursor control or cursor directing device 416 coupled to the bus 410 for communicating user input information and command selections to the processor(s) 402. The cursor directing device 416 can be implemented using a number of well known devices such as a mouse, a track ball, a track pad, an optical tracking device, a touch screen, etc. Alternatively, it is appreciated that a cursor can be directed and/or activated via input from the alphanumeric input device 414 using special keys and key sequence commands. The present embodiment is also well suited to directing a cursor by other means such as, for example, voice commands.

The system 400 of FIG. 4 can also include a computer usable mass data storage device 418 such as a magnetic or optical disk and disk drive (e.g., hard drive or floppy diskette) coupled with bus 410 for storing information and instructions. An optional display device 412 is coupled to bus 410 of system 400 for displaying video and/or graphics. It should be appreciated that optional display device 412 may be a cathode ray tube (CRT), flat panel liquid crystal display (LCD), field emission display (FED), plasma display or any other display device suitable for displaying video and/or graphic images and alphanumeric characters recognizable to a user.

Accordingly, an embodiment of the present invention enables transition from one server microprocessor architecture to a different server microprocessor architecture without it being overly expensive.

The foregoing descriptions of specific embodiments of the present invention have been presented for purposes of illustration and description. They are not intended to be exhaustive or to limit the invention to the precise forms disclosed, and it is evident many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for providing automatic detection of different microprocessor architectures within a system, said method comprising:
determining whether a first microprocessor architecture or a second microprocessor architecture is resident to said system;
provided said first microprocessor architecture is resident to said system, providing first data to activate first architecture support of said system associated with said first microprocessor architecture; and
provided said second microprocessor architecture is resident to said system, providing second data to activate second architecture support of said system associated with said second microprocessor architecture.

2. The method as described in claim 1 wherein said first architecture support comprises first firmware corresponding to said first microprocessor architecture and said second architecture support comprises second firmware corresponding to said second microprocessor architecture.

3. The method as described in claim 1 wherein said first architecture support comprises first circuitry associated with said first microprocessor architecture and said second architecture support comprises second circuitry associated with said second microprocessor architecture.

4. The method as described in claim 1 wherein said determining whether said first microprocessor architecture or said second microprocessor architecture is resident to said system comprises detecting a difference between said first microprocessor architecture and said second microprocessor architecture.

5. The method as described in claim 1 wherein said determining whether said first microprocessor architecture or said second microprocessor architecture is resident to said system comprises utilizing a voltage sensor at a microprocessor pin common to said first microprocessor architecture and said second microprocessor architecture.

6. The method as described in claim 1 wherein said determining whether said first microprocessor architecture or said second microprocessor architecture is resident to said system comprises reading memory resident to said first microprocessor architecture or said second microprocessor architecture.

7. The method as described in claim 1 wherein said first microprocessor architecture or said second microprocessor architecture are not electrically coupled to said system simultaneously.

8. The method as described in claim 1 wherein said system comprises a computer system.

9. A system for automatically detecting different microprocessor architectures within a computer system, said system comprising:
means for ascertaining whether a first microprocessor architecture or a second microprocessor architecture is coupled to said computer system;
means for furnishing a first data to said computer system to activate first architecture support of said computer system associated with said first microprocessor architecture, provided said first microprocessor architecture is coupled to said computer system; and
means for furnishing a second data to said computer system to activate second architecture support of said computer system associated with said second microprocessor architecture, provided said second microprocessor architecture is coupled to said computer system.

10. The system as described in claim 9 wherein said first architecture support comprises first architecture-specific firmware associated with said first microprocessor architecture and said second architecture support comprises second architecture-specific firmware associated with said second microprocessor architecture.

11. The system as described in claim 9 wherein said first architecture support comprises first circuitry associated with said first microprocessor architecture and said second architecture support comprises second circuitry associated with said second microprocessor architecture.

12. The system as described in claim 9 wherein said means for ascertaining whether said first microprocessor architecture or said second microprocessor architecture is coupled to said computer system comprises detecting a difference between said first microprocessor architecture and said second microprocessor architecture.

13. The system as described in claim 9 wherein said means for ascertaining whether said first microprocessor architecture or said second microprocessor architecture is resident to said system comprises utilizing a voltage sensor at a microprocessor pin common to said first microprocessor architecture and said second microprocessor architecture.

14. The system as described in claim 9 wherein said means for ascertaining whether said first microprocessor architecture or said second microprocessor architecture is resident to said system comprises reading memory resident to said first microprocessor architecture or said second microprocessor architecture.

15. The system as described in claim 9 wherein said first microprocessor architecture or said second microprocessor architecture are not electrically coupled to said system simultaneously.

16. A computer readable medium having computer readable code embodied therein for causing a system to perform:
deciding automatically whether a first microprocessor architecture or a second microprocessor architecture is electrically coupled to a computer;
provided said first microprocessor architecture is electrically coupled to said computer, presenting first data to said computer to enable first architecture support of said computer associated with said first microprocessor architecture; and
provided said second microprocessor architecture is electrically coupled to said computer, presenting second data to said computer to enable second architecture support of said computer associated with said second microprocessor architecture.

17. The computer readable medium as described in claim 16 wherein said first architecture support comprises firmware associated with said first microprocessor architecture and said second architecture support comprises firmware associated with said second microprocessor architecture.

18. The computer readable medium as described in claim 16 wherein said first architecture support comprises first circuitry associated with said first microprocessor architecture and said second architecture support comprises second circuitry associated with said second microprocessor architecture.

19. The computer readable medium as described in claim 16 wherein said deciding whether said first microprocessor architecture or said second microprocessor architecture is electrically coupled to said computer comprises detecting a difference between said first microprocessor architecture and said second microprocessor architecture.

20. The computer readable medium as described in claim 16 wherein said determining whether said first microprocessor architecture or said second microprocessor architecture is electrically coupled to said computer comprises utilizing a voltage sensor at a microprocessor pin common to said first microprocessor architecture and said second microprocessor architecture.

21. The computer readable medium as described in claim 16 wherein said determining whether said first microprocessor architecture or said second microprocessor architecture is electrically coupled to said computer comprises reading memory of said first microprocessor architecture or said second microprocessor architecture.

22. The computer readable medium as described in claim 16 wherein said first microprocessor architecture or said second microprocessor architecture are not electrically coupled to said computer simultaneously.
